(19) United States
(12) Patent Application Publication
(10) Pub. No.: US 2023/0061598 A1
(43) Pub. Date: Mar. 2, 2023

(54) MOTION PLATFORM

(71) Applicants: Morgan William Weinberg, Fairfax, VA (US); Burton Allen Miller, Washington, DC (US)

(72) Inventors: Morgan William Weinberg, Fairfax, VA (US); Burton Allen Miller, Washington, DC (US)

(21) Appl. No.: 17/459,106

(22) Filed: Aug. 27, 2021

(51) Int. Cl. A63G 31/16; A63F 13/28; A63G 31/02; A63F 13/90

(52) U.S. Cl. CPC A63G 31/16; A63F 13/28; A63G 31/02; A63F 13/90; A63F 2300/302

(57) ABSTRACT

The present invention relates to a motion platform that moves in two degrees of rotational freedom that can be used to simulate board activities such as skateboarding and surfing and is readily extended to simulate other experiences such as skiing, driving, flying, and even boxing, through the attachment of the appropriate apparatus. The motion platform comprises a pivotable table attached to a base with two toothed belts attached at quadrants of the table, with the belts attached to a pair of ball-screws mounted orthogonally in the base. Pulleys mounted in the quadrants of the base redirect the belts so that they travel parallel to the ball screws. Cams maintain proper tension in the belts as the table pivots. The motion platform includes a programmable controller that can drive the table in terms of position but can also drive the platform according to a mathematical model where the physical table is attached to a virtual table through virtual springs with dynamic virtual spring rates and virtual dampers with dynamic virtual coefficients of damping. Here, position commands are applied not to the physical table but to the virtual table with the final position of the physical table determined through the solution of spring-mass-damper equations of motion using the dynamic spring rates, dynamic coefficients of damping, measured torque on the table, and where the mass corresponds to virtual moments of inertia of a simulated board such as a paddle board with the moment of inertia of the physical table and connected moving parts factored out; the mathematical model able to simulate a variety of environments such as a paddle board on water with waves, a snowboard on fresh powder, or even quicksand.

### FIELD OF THE INVENTION

The present invention relates to a motion platform principally for use in motion simulation for gaming, virtual reality, exercise, or any application requiring high force and at least two degrees of rotational freedom.

### BACKGROUND OF THE INVENTION

Motion platforms and specifically, two-degree-of-freedom (2DOF) motion platforms that pitch and roll have been disclosed in the patent record and are cur-rently manufactured by various companies. The typical embodiment, as disclosed in U.S. Pat. No. 8,298,845B2, employs two gearmotors connected to a pivotable table via pitman arms and connecting rods that work in conjunction to pivot the table in two degrees of freedom. The typical use case for these platforms is car racing and flying simulation where a rig comprised of a seat, steering wheel or yoke, pedals, and other necessary bits is either integral with or bolted to the platform.

The present invention aims to extend these use cases to include simulated board sports such as skateboarding, surfing, and snowboarding to whole new cate-gories of activities such as balancing games and workouts that entail balance, agility, and footwork. On a 1 m by 1 m table, a 200 kg rider standing at a cantilever of 45 cm will yield 844 N-m of table torque. A high-torque 400-watt servo may be able to output on the order of 2 N-m of continuous torque, which in turn means that a table-articulating mechanism using this servo must have a mechanical advantage over 400:1 just to support this static load. As the rider interacts with the table, adding inertial forces on top of the static load, table torques can increase substantially.

As most 2DOF platforms, including the present invention, are designed for compatibility with domiciles and small-business locations, there is a limit to the power draw that may be demanded by the platform. Standard household power circuits, worldwide, range between 10-20 amps at 120-240 volts, with maximum power outputs of 1800 watts at the bottom end of the range for large markets such as North America. Peak-power consumption for the platform, therefore, should not exceed on the order of 1500 watts to avoid tripping a breaker. A platform fitted with two servos rated at 400 continuous watts and 1100 peak watts—with the idea that the combined power of both servos would also be limited to 1100 watts—would operate within this envelope with room for additional servos to provide further degrees of freedom such as yaw.

Current gearmotor-based platforms aren't well adapted to handling board simulations with large cantilevered dynamic loads. With the aforementioned limit on servo size, a substantial gear train is necessary to develop the necessary mechanical advantage. For example, DOF Reality Motion Simulators (https://dofreality.com/) makes a gearmotor-based 2DOF simulator with an advertised torque of 25 N-m, which is sufficient to articulate a driving rig with a rider where the center of gravity is largely in line vertically with the pivot point, but falls short of the torque necessary to handle board simulations. Additional gear sets may be added to increase mechanical advantage and output torque, but this will reduce output speed and add more backlash to the system. Increased backlash reduces simulation resolution where it becomes impossible to transmit small vibrations to the rider, impairing the experience.

The gearmotor-pitman-arm approach suffers from other trade-offs. A number of 2DOF machines on the market limit table pivot angle to +/−10 degrees, which is not sufficient for board simulations where larger deflections are needed for a full experience, keeping in mind that a minimum of 2 degrees at both ends of the range are needed for deceleration. Maximum travel can be achieved by rotating the pitman arms from −90 degrees to +90 degrees, but as the pitman arms approach these sinusoidal minimum and maximum, table angular speed goes to zero and the ratio of servo speed to table speed goes to zero, which translates to sluggish and unrespon-sive table action near the ends of travel. To counter this, the pitman arms can be lengthened with angular travel limited to −45 degrees to +45 degrees, or conversely, the attachment points to the table brought closer to the pivot point, or both, but any of those options would place a larger torque on the gearmotor, all else being equal.

The other challenge with the gearmotor approach for board simulations is keeping the table low to the floor—at a comfortable height for the rider. Ideally, the edge of the table should almost touch the floor at maximum deflection. To achieve this, the gearmotors have to be placed inboard close to the pivot point, which again, increases torque on the gearmotor.

A further challenge in simulating board activities relates to control of the servos. Typically, servos are programmed to move a specific distance at a specific speed. They consume as much power as necessary, up to a limit, to satisfy the speed command. To simulate a rider on a paddle board, for example, standard positional control doesn't suffice because table deflection must account for torque inputs from the rider in real time. If the rider puts pressure on the left foot, the table should lean left but only to the point where the increasing buoyancy of the virtual paddle board is in balance with the tipping force. The accurate response would entail some oscillation as an actual paddle board would bob a number of cycles before settling down. Virtual waves further complicate the scenario where the buoyancy force increases on one side of the table and then the other as the wave travels under the board. To handle these scenarios, the control system must know, in real time, the torques on the table and incorporate these data into an algorithm modeling the virtual environment to properly drive the servos.

### OBJECTS OF THE INVENTION

It is an object of the invention to pivot a table in two degrees of rotational freedom—pitch and roll—using computer-controlled servo-based actuators.

It is a further object that the invention be well adapted for the simulation of board sports such as skateboarding, surfing, and snowboarding, and other activities and exercise routines yet to be invented that entail balance, agility, and footwork.

It is a further object that the table be able to deflect to angles of at least +/−17 degrees with at least +/−15 degrees of active range with +/−2 degrees of deceleration angle at the end of travel.

It is a further object that the invention be extensible—allowing for the attachment and integration of other simulation equipment such as race-car rigs, flying rigs, yaw tables, skiing rigs, boxing torsos, and apparatuses yet to be invented to the table.

It is a further object that the table sit at a minimal height above the floor to be comfortable for a rider standing on and interacting with the table and to accommodate the typical domicile ceiling height.

It is a further object that the table be capable of handling large torques such as those generated by a rider interacting with the table at an offset from the axis of pivot.

It is a further object that the mechanisms driving the table have negligible backlash, allowing the table to reverse rapidly in response to rider and controller inputs, enhancing the experience.

It is a further object that the driver mechanism be highly efficient and reversible such that forces on the table are substantially transmitted back to the servos, allowing the servo controllers to derive table forces in real time.

It is a further object that the ratio of servo speed to table deflection speed be fairly constant through out the deflection range to maintain responsiveness and allow substantial torque transmission back to the servo at all deflection angles.

It is a further object that with knowledge of table forces in real time, the controller be able to simulate fluid environments such as a rider on a paddle board on a wavy body of water.

### SUMMARY OF THE INVENTION

The motion platform has a table that pivots in two degrees of rotational freedom, providing for the simulation of board sports such as skateboarding, surfing, and snowboarding, and other activities and exercise routines yet to be invented that entail balance, agility, and footwork. Further, the platform is extensible where an additional apparatus such as a racing rig or skiing rig may be attached and integrated with the platform controller. The platform, which is not limited to motion simulation, can handle high-torque loads and is capable of large deflection angles in backlash-free, precise motion.

The table is pivotally mounted on a post that is attached to a base. The base is comprised of two arms mounted orthogonally to each to other to the post, with one arm bridging the other via a miter joint. Each arm is comprised of a square tube within which is mounted a ball-screw assembly and a belt-tensioning assembly. Servos drive the ball screws with a programmable controller coordinating and driving the servos.

Two toothed belts are attached underneath the table via spherical bearings at distal edges of the table with the attachment points of the first belt orthogonal to the attachment points of the second belt. Each belt is fished from a first attachment point under a corner pulley, over a cam assembly, under a second pulley (these elements included in the belt-tensioning assembly), underneath a ball screw and affixed to a ball-screw nut, under another corner pulley (these elements included in the ball-screw assembly), and up to a second attachment point. The belt-tensioning assembly in the bent square tube includes an additional pulley to redirect the belt up and over the miter joint. The first belt pivots the table in the XZ plane, and the second belt pivots the table in the YZ plane, orthogonal to the XZ plane.

The aim of having one base arm bridging the other is to allow for longer ball screws than would otherwise be possible if the two square tubes intersected each other in a tee, thereby maximizing belt travel for a given base footprint. This arrangement, in conjunction with the belts being configured to run under the ball screws, allows over +/−17 degrees of table deflection while keeping the table height to a minimum.

As the table pivots from the horizontal position, the length of belt on the expanding side grows faster than the belt on the shrinking side decreases, which means that a slight amount of slack must be given to the belt as the deflection angle increases from 0 and taken away as the table returns to horizontal. The cam assembly gives and takes away the requisite slack to maintain substantially constant tension in the belt throughout the range of table deflection.

The cam assembly is comprised of a toothed pulley that engages the belt with the pulley rotatably and fixably attached to a pair of cams, with identical profiles, sandwiching the pulley. The cam assembly is rotatably attached to a swing arm, which in turn is rotatably attached to the belt-tensioning assembly. The cam pair rides on a roller that is slidably and fixably attached to the belt-tensioning assembly with adjustment thereof tensioning or un-tensioning the belt. Adjustment between the cam and the belt is necessary to fine-tune timing between the two. For example, during initial setup, when the table is horizontal, the cam may be a fraction off from top dead center, in which case a small rotational adjustment can fix it at the proper angle. As belt translation rotates the cam assembly, the distance between the toothed pulley axis and roller axis changes according to the cam profile, adding or removing belt slack as necessary.

Driving each ball screw via toothed belts are 400-W (1100-W-peak) servos. Demonstrating the mechanical advantage of a ball screw, a 20-mm pitch-diameter ball screw with a 10-mm lead and an efficiency of 95%, has a mechanical advantage of 628 N of linear force per N-m of ball-screw torque. Here, 2 N-m of servo torque is sufficient to support a 200 kg load at a 45 cm offset from the pivot point. Backlash in the system is negligible as the main belt is fixed to the ball-screw nut. Backlash in the ball-screw nut is near zero, and backlash in the toothed-belt coupling between the servo and ball screw is also negligible. The efficiency of a ball screw with a lead angle over 5 degrees is at least 95% for both forward and reverse operation, the latter where linear force on the ball nut is converted to ball-screw torque. Toothed belts typically offer an efficiency of 98%, leaving overall servo-to-table efficiency at 91-93% working both forward and reverse. High forward and reverse efficiencies with minimal friction losses allow the servos and controller to accurately sense torques acting upon the table.

To simulate a fluid environment, such as a rider on paddle board, the programmable controller executes a mathematical model comprising a virtual table that pivots in the XZ and YZ planes, where in each plane the physical table is connected to the virtual table through a virtual torsion spring with a dynamic virtual spring rate and a virtual torsion damper with a dynamic virtual damping coefficient.

Deflections of the physical table are determined by solving the equations of motion in each plane for a rotational spring-mass damper system comprised of the virtual spring and virtual damper, where the mass is a virtual moment of inertia of a simulated ridable object such as a paddle board with the moment of inertia of the physical table and connected moving parts factored out, and where the applied torque on the system is the measured external torque on the physical table.

Illustrating how this works in practice, to simulate a sidewalk, for example, the virtual spring rates in the XZ and YZ planes are set to infinite values, effectively tying the physical table to the virtual table with inflexible rods. As the rider steps off center, the servos, which do not have position commands, will use as much current as necessary to resist any table deflection. Here, if a servo is issued a position command, the table will simply pivot the rider to the specified angle at the specified speed.

Imagine a different scenario, where the spring rates are zero, but the virtual damping coefficients are non-zero and somewhat substantial. As the rider steps off center, the controller, sensing the applied torque, will apply the mathematical model and slowly pivot the table, lowering the rider at roughly a constant rate of deflection as determined by the damping coefficient until a soft limit is reached, at which point the table will decelerate to a stop. If the rider steps to the other side of the table, it will pivot similarly the other direction, eventually coming to stop.

In another scenario, if damping coefficients are zero with non-zero spring rates, stepping off center will cause the table to bounce a certain frequency in per-petuity. As damping coefficients are increased, the table oscillations will decrease in magnitude over time. Here, if the virtual table is deflected, the response of the physical table is determined through the solution of the spring-mass-damper equation, where in this case, the table might lift the rider and oscillate a few cycles. Imagine a wave traveling underneath a paddle board where one side is raised a certain amount in response to the wave, followed quickly by the other side being raised as the wave travels underneath the board, followed by some bobbing back and forth as the board settles down. The spring-mass damper model provides a first order approximation of this motion. By allowing the coefficients in the equation—the spring rate, damping coefficient, and moment of inertia—to be dynamic, further levels of refinement can be applied to the simulation.

As noted, a virtual moment of inertia may also be specified. For example, with an infinite moment of inertia, the table, in response to a rider stepping off center, would stay rock solid. Interestingly, pivoting the virtual table through even a stiff spring would not disturb the physical table's deflection angle either. At the other extreme, if the moment of inertia were set to zero, along with the spring rate and coefficient of damping, stepping off center, would be like stepping off a cliff as the table would pivot at the falling rate of the foot. In practicality, this is not possible, as some force must be transmitted to the servo, but low moments of inertia are possible to simulate a balance board, for example.

### BRIEF DESCRIPTION OF THE DRAWINGS

For a more complete understanding of the invention, reference is made to the following description and accompanying drawings, in which:

FIG. 1 is a top view in perspective of a motion platform;

FIG. 2 is a bottom view in perspective of a motion platform;

FIG. 3 is a view in section of a motion platform in plane XZ;

FIG. 4 is a view in section of a motion platform in plane YZ;

FIG. 5 is a view in section of a motion platform in plane YZ;

FIG. 6 is a view of a mathematical model for a motion-platform controller;

FIG. 7 is a view of a mathematical model for a motion-platform controller; and

FIG. 8 is a graph showing the mechanical responsiveness of a motion-platform.

### DETAILED DESCRIPTION OF THE PREFERRED EMBODIMENT

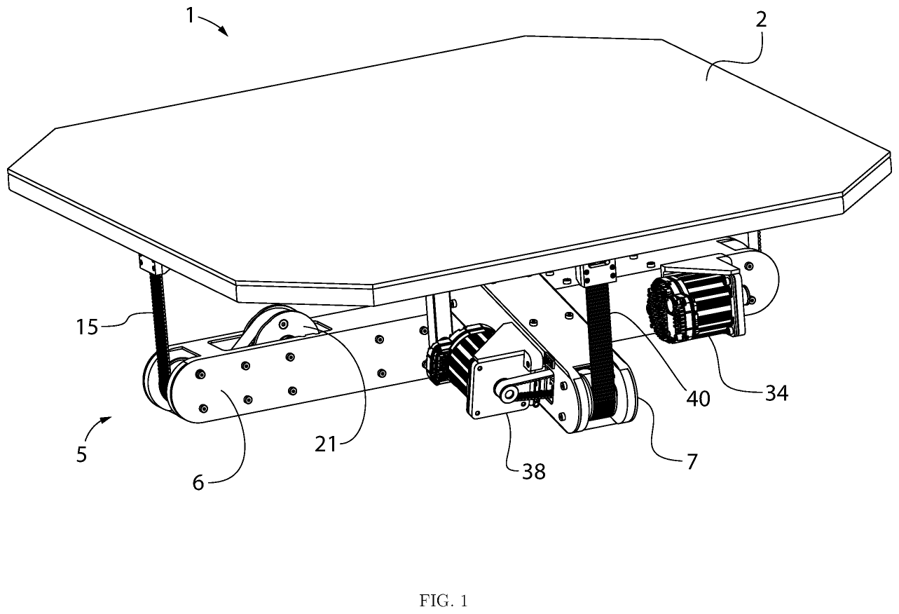

Referring to FIGS. 1-5, a motion platform 1 has a table 2 that pivots in two degrees of rotational freedom, providing for the simulation of board sports such as skateboarding, surfing, and snowboarding, and other activities and exercise routines yet to be invented that entail balance, agility, and footwork. Further, the platform is extensible where an additional apparatus such as a racing rig or skiing rig may be attached and integrated with the platform controller. Motion platform 1, which is not limited to motion simulation, can handle high-torque loads and is capable of large deflection angles in backlash-free, precise motion.

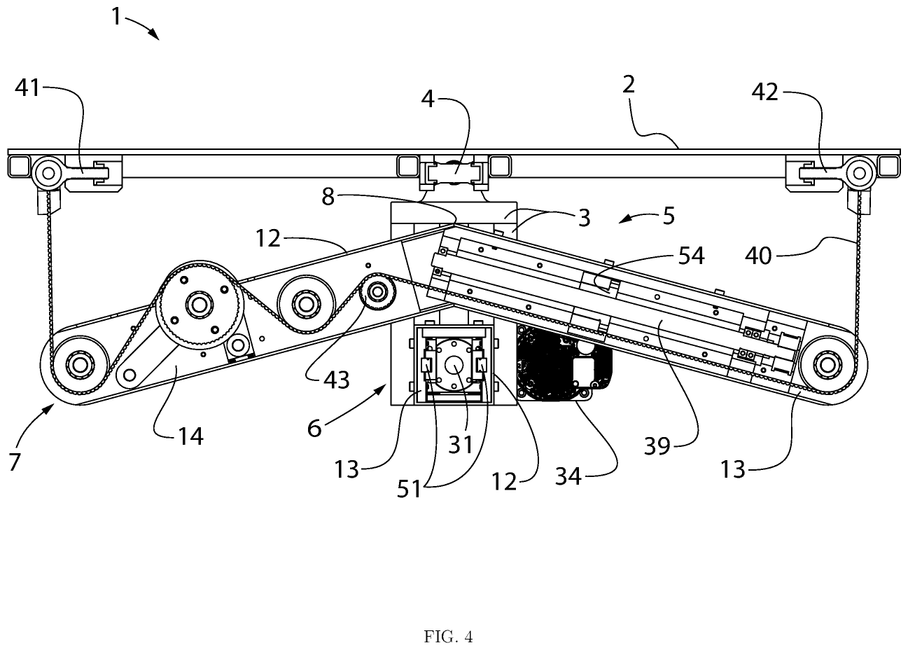

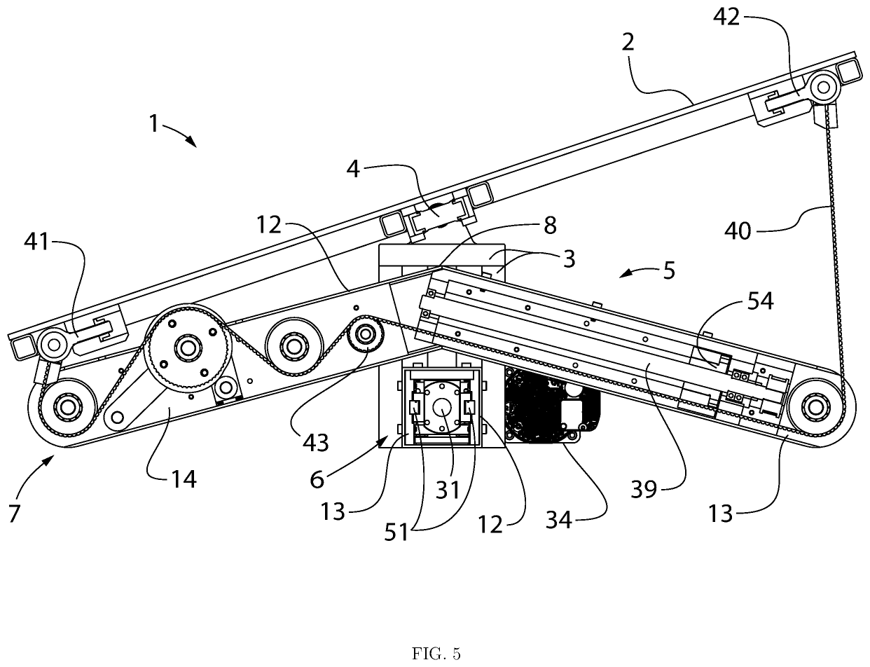

Table 2 is attached to a post 3 via a joint 4 that provides two degrees of rotational freedom, which in the preferred embodiment is a universal joint. Post 3 is attached to a base 5, which is comprised of a base arm 6 and a base arm 7, mounted orthogonally to each other, base arm 6 and post 3 defining a plane XZ, and base arm 7 and post 3 defining a plane YZ, plane YZ being orthogonal to plane XZ. FIGS. 4 and 5 show base arm 7 in section bridging base arm 6 via a miter joint 8.

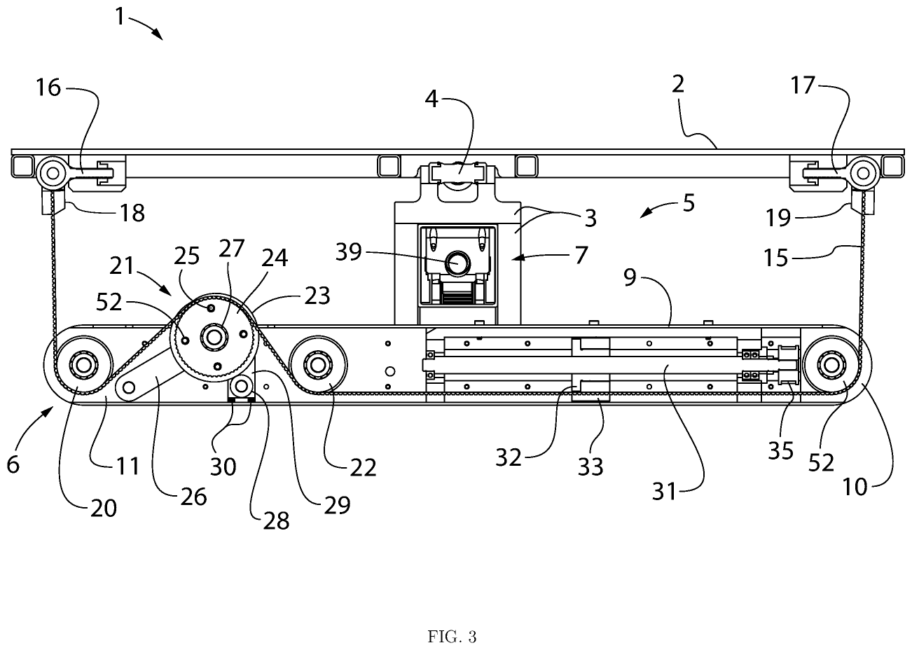

FIG. 3 shows base arm 6 in section, which is comprised of a square tube 9, within which are mounted a belt-tensioning assembly 11 and a ball-screw assembly 10. FIGS. 4 and 5 show base arm 7 in section, which is comprised of a square tube 12, within which are mounted a belt-tensioning assembly 14 and a ball-screw assembly 13.

As shown in FIG. 3, attached to table 2 at opposite edges, is a toothed belt 15 via a tie-rod end 16 and a tie-rod end 17 that each allow two degrees of rotational freedom. Critically, the centers of rotation of tie-rod ends 16 and 17 are collinear with the center of rotation of joint 4 and coplanar with plane XZ. Toothed belt 15 is attached to tie-rod ends 16 and 17 via a belt clamp 18 and a belt clamp 19. Looking from left to right, toothed belt 15 runs down from belt clamp 18, through belt-tensioning assembly 11, through ball-screw assembly 10, and up to belt clamp 19.

In FIG. 3, more specifically, toothed belt 15 runs underneath a smooth pulley 20, over a cam assembly 21, and under a smooth pulley 22, with smooth pulleys 20 and 22 rotatably mounted to belt-tensioning assembly 11. Cam assembly 21 is comprised of a pair of cam plates 23 that sandwich a toothed pulley 24 with an array of cam bolts 25 clamping cam assembly 21 together. Toothed belt 15 engages toothed pulley 24 allowing translation of toothed belt 15 to urge rotation of cam assembly 21. The primary reason that teeth are needed in toothed belt 15 is to drive cam assembly 21.

Cam assembly 21 is rotatably attached to a swing arm 26 via a pair of cam bearings 27, with swing arm 26 rotatably attached to belt-tensioning assembly 11. Cam plates 23 ride on a roller 28 that is rotatably mounted in a roller carriage 29, which is slidably mounted in belt-tensioning assembly 11. Roller carriage 29 may be advanced upward relative to belt-tensioning assembly 11 via a set of set screws 30, thereby causing roller 28 to urge cam assembly 21 up against toothed belt 15, adding pretension thereto. A spring (not shown) may be added as well to further urge cam assembly 21 upward, although table 2 and toothed belt 15 have a certain stiffness whereby a minimal deflection thereof can add tension to toothed belt 15 with fine-tuning possible via set screws 30.

Coming out of belt-tensioning assembly 11, toothed belt 15 runs underneath a ball screw 31 and a smooth pulley 52, both rotatably attached to ball-screw assembly 10. Toothed belt 15 is attached to a ball nut 32 via a belt clamp 33 where rotation of ball screw 31 causes ball nut 32 to translate, in turn, causing toothed belt 15 to translate, which in turn causes table 2 to pivot in plane XZ. Ball nut 32 rides on a pair of linear-guide rails 51, shown in section in FIG. 4, that stabilize and prevent the rotation of ball nut 32 as it translates along ball screw 31.

As table 2 pivots counter-clockwise from horizontal, the length of belt between tie-rod end 17 and smooth pulley 52 grows faster than the rate at which the length between tie-rod end 16 and smooth pulley 20 shrinks, necessitating that slack be added to toothed belt 15 at a rate governed by the change in perimeter. Conversely, as table 2 pivots back clockwise, slack needs to be removed. This is the purpose of belt-tensioning assembly 11, whereby the pivoting of cam assembly 21 on swing arm 26 adds or removes slack as needed in toothed belt 15 to maintain roughly constant tension therein as table 2 pivots through its range. The pivot angle of swing arm 26 is governed by the geometry of cam plates 23 in contact with roller 28 where necessary changes in contact radius are timed with translation of toothed belt 15.

Because the timing between cam plates 23 and toothed belt 15 is critical, the angle between cam plates 23 and toothed pulley 24 may be fine-tuned to advance or retard timing between the two. Toothed pulley 24 has an array of oversized holes 53 through which cam bolts 25 pass that allow cam plates 23 to be rotated relative to toothed pulley 24 a small angle and fixed at that angle by tightening cam bolts 25. Both toothed pulley 24 and cam plates 23 are mounted on cam bearings 27 allowing the two to rotate about a common axis.

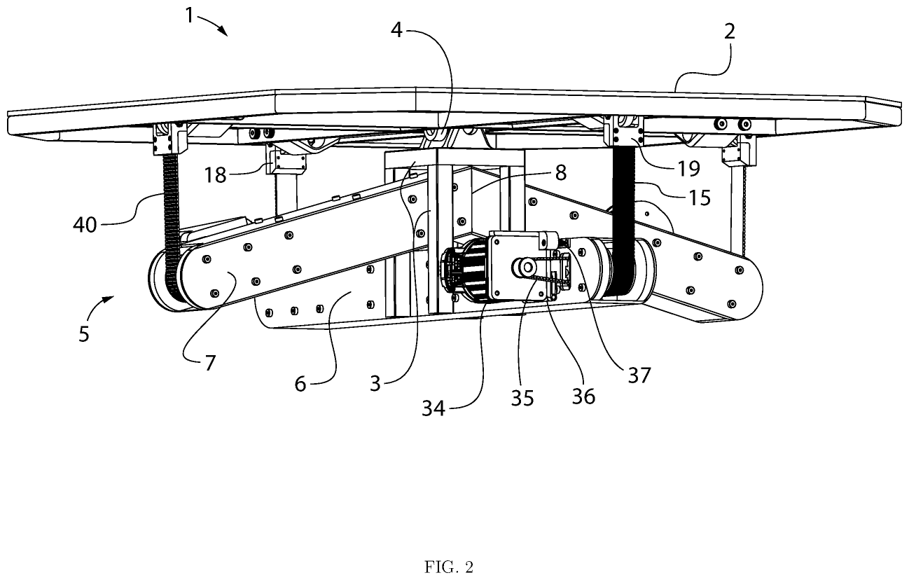

Referring to FIG. 2, driving ball screw 31 is a servo 34 via a belt drive 35 with servo 34 rotatably mounted to base arm 6 via a hinge 36 with tension in belt drive 35 adjusted via a tensioning screw 37. Similarly, in FIG. 1, a servo 38 drives a ball screw 39, which is rotatably mounted in ball-screw assembly 13 as shown in FIGS. 4 and 5. Driving servos 34 and 38 and coordinating motion there between is a programmable controller (not shown). The motion of table 2 is substantially free from backlash by virtue of ball-screw mechanism, in general, having negligible backlash and the final connection to servo 34, made via belt drive 35, also having negligible backlash.

FIGS. 4 and 5 show a toothed belt 40, which, looking from left to right, runs from a tie-rod end 41, down through belt-tensioning assembly 14 and ball-screw assembly 13, and up to a tie-rod end 42, with tie-rod ends 41 and 42 being attached to table 2 on edges orthogonal to tie-rod ends 16 and 17. As is the case with the XZ plane, the centers of rotation of tie-rod ends 41 and 42 are collinear with the center of rotation of joint 4 and coplanar with plane YZ. FIG. 5 shows table 2 at full deflection—18.5 degrees. Notice ball nut 54 is at its end of travel on ball screw 39.

Ball-screw assembly 13 is identical to ball-screw assembly 10. Belt-tensioning assembly 14 is nearly identical to belt-tensioning assembly 11 with the only difference being the inclusion of a toothed pulley 43, which is needed to redirect toothed belt 40 over miter joint 8. Toothed pulley 43 only requires teeth because it engages the tooth side of toothed belt 40. Functionally, the cam-tensioning and ball-screw mechanisms work identically in both base arms 6 and 7.

Miter joint 8 in base arm 7 allows the length of ball-screw assemblies 10 and 13 to be maximized for a given motion platform 1 footprint. Running toothed belts 15 and 40 underneath ball screws 31 and 39 minimizes the height of post 3 for a given maximum table 2 deflection angle.

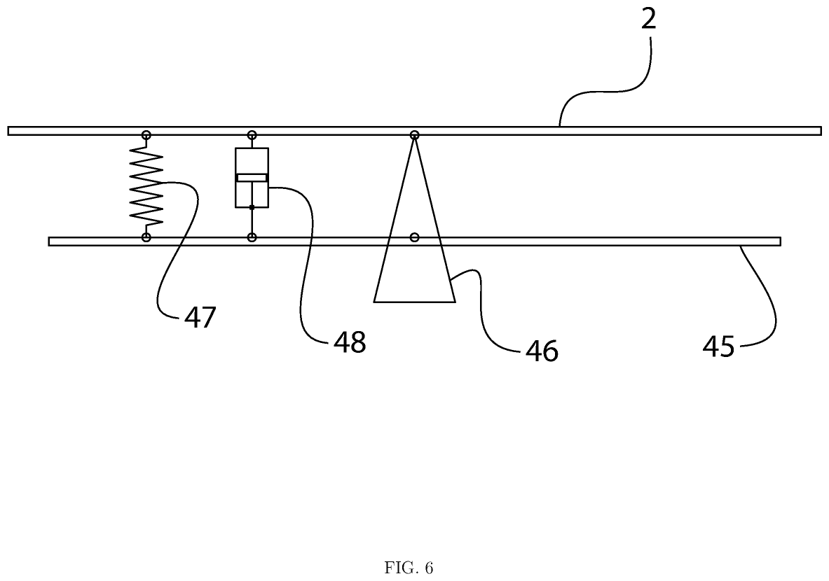

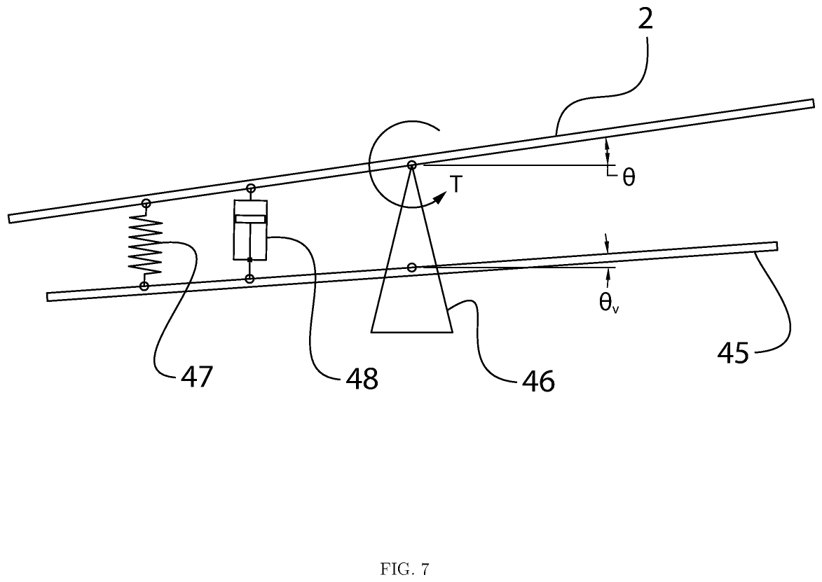

FIGS. 6 and 7 show a mathematical model 44 for motion in the XZ and YZ planes that may be run by the programmable controller to drive table 2 deflection to simulate fluid environments such as a rider on a paddle board on water (not shown). In this model, table 2 and a virtual table 45 are both rotatably connected to a virtual base 46 and connected to each other via a virtual spring 47 with a dynamic virtual spring rate and a virtual damper 48 with a dynamic virtual coefficient of damping. Here, “dynamic” refers to a variable set via equation or lookup table or the like wherein, as the mathematical model is executing, the values may change.

Note that in FIGS. 6 and 7, virtual spring 47 and virtual damper 48 are purely illustrative. Mathematically, virtual spring 47 is a torsion spring and virtual damper 48 is a torsion damper with the center of pivot of virtual table 45 being concentric with joint 4. Also, in mathematical model 44, virtual spring 47 resists both clockwise and counter-clockwise rotation from horizontal.

The deflection of table 2 is determined by solving the equations of motion for a rotational spring-mass-damper system comprised of virtual spring 47 and virtual damper 48, where the applied torque on the system is the measured external torque applied to table 2 shown in FIG. 7 as torque T, and where the mass is the moment of inertia of a board or craft (not shown) with the actual moment of inertia of table 2 and connected moving parts factored out. The board or craft may be a physical object, or a portion thereof, attached to table 2 or a virtual object, in which case the moment of inertia would also be virtual. FIGS. 6 and 7 show motion in the XZ plane. Motion in the YZ plane is governed by its own rotational spring-mass-damper system with its own spring, damping, and inertia parameters.

In the XZ plane, torque T acting upon table 2 is sensed by servo 34 in concert with the programmable controller. To derive torque T accurately when table 2 is either accelerating or decelerating, its moment of inertia and that of the connected moving parts must be accounted for. Keeping table 2's moment as low as possible facilitates this derivation. Further, a drive mechanism between table 2 and servo 34 that allows torque to be transferred thereto without significant friction losses is also critical to accurately sensing torque T. Ball screws with lead angles over 5 degrees, as would be specified in the preferred embodiment, typically offer efficiencies over 95% for both forward and reverse operation, the latter where linear force on the ball nut imparts a torque to the ball screw. With toothed-belt drives having efficiencies of 98%, the overall table 2 to servo 34 efficiency ranges between 91-93%.

FIG. 7 shows a snapshot of table 2 in motion with applied torque T with the programmable controller running mathematical model 44. Here, virtual table 45 has been deflected to an angle θᵥ, and through the solution of the spring-mass-damper equations of motion, table 2 deflects to θ, which is about double θᵥ. Comparing FIG. 7 with FIG. 6, virtual spring 47 with a positive, less-than-infinite spring rate has been compressed a certain amount. If the spring rate were infinite, virtual spring 47 would essentially function as an inflexible rod causing the deflection of table 2 to exactly track the deflection of virtual table 45. Alternatively, if virtual damper 48 were infinitely stiff, the same result would apply—table 2 would exactly track virtual table 45 in deflection.

FIG. 7 could represent a variety of simulations. Applied torque T, for example, could represent a rider on a virtual paddle board shifting his weight to the left with a wave represented by virtual table 45 traveling left to right, which is now cresting on the right side of the board. As the wave continues its travel, virtual table 45 levels out, compressing virtual spring 47, urging table 2 clockwise against torque T. In this scenario, the coefficient of damping of virtual damper 48 would be set to a value that would cause table 2 to oscillate to mimic the bobbing of an actual paddle board, eventually settling down to a deflection angle θ where the simulated buoyancy of the virtual paddle board is in balance with torque T.

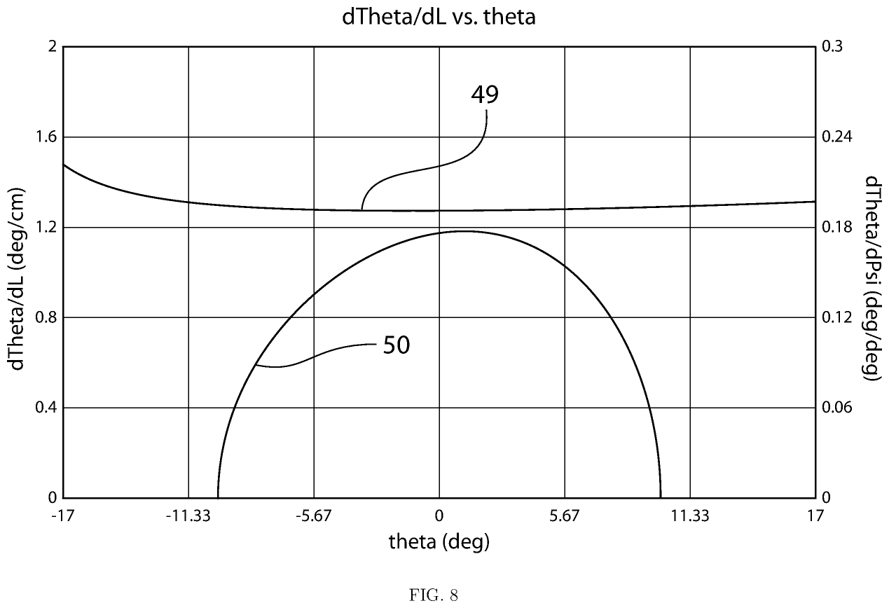

FIG. 8 is a graph that shows the responsiveness of table 2 at various deflection angles. Specifically, a plot 49 shows the incremental change in table 2 angle dθ with respect to the incremental translation dL of toothed belt 15 from table 2 deflection angle −17 degrees to +17 degrees. Ideally, plot 49 should be flat, which would indicate that the amount of incremental servo 34 rotation needed for a given incremental table 2 deflection would remain constant regardless of table 2 angle. As shown, plot 49 approaches the ideal.

In contrast, a plot 50 in FIG. 8 shows the responsiveness of a gearmotor-based motion platform (not shown) where a pitman-arm travel of −90 degrees to +90 degrees translates to a table deflection of −10 degrees to +10 degrees. At the extremes, responsiveness goes to 0 where incremental rotation of the servo driving the gearmotor yields nearly zero incremental table deflection. Also, note that when the pitman arms are at the extremes of −90 degrees or +90 degrees, no torque on the table can be transmitted back to the servo. As discussed above, for a given table-deflection range, pitman-arm travel can be reduced to stay out of the low-responsiveness bands if the pitman arm is made longer or the attachment point to the table is brought closer to the pivot point, or both, but this will increase the torque demand on the gearmotor.

It may thus be seen that the objects set forth above, among those made apparent from the preceding description, are efficiently attained and, because certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed:

1. A motion platform, comprising:
a table rotatably mounted to a base via a joint means;
a belt means with each distal end attached to said table at points straddling said joint means;
a linear-actuator means attached to said base with said linear-actuator means having a driveable element that is attached to said belt means such that translation of said driveable element tensions said belt means, which in turn pivots said table about said joint means;
at least one pulley means attached to said base that redirects said belt means such that said belt means travels substantially parallel to said linear-actuator means;
a tensioning means attached to said base that takes up or gives slack in said belt means that occurs as a result of geometry changes as said table pivots.

2. A motion platform as in claim 1, wherein said belt means runs underneath said linear-actuator means, thereby minimizing the height of said motion platform for a given maximum deflection angle of said table.

3. A motion platform as in claim 1, wherein said belt means has teeth allowing for positive engagement with a toothed-pulley means.

4. A motion platform as in claim 3, wherein said tensioning means comprises a cam affixed to a toothed-pulley means that engages said belt means, said toothed-pulley means rotatably mounted to a cam carriage that is rotatably or slidably mounted to said base, with said cam contacting a roller that is rotatably mounted to said base, whereby translation of said belt means causes said toothed-pulley means to rotate in congruence with said cam, with said cam urging said cam carriage to move a distance necessary to take up or give slack to said belt means as needed to prevent over-tension or under-tension of said belt means as said table pivots through its range of travel.

5. A motion platform as in claim 4, wherein said cam can be rotatably adjusted and fixed at a certain angle with respect to said toothed-pulley means to adjust and set timing between said cam and said belt means.

6. A motion platform as in claim 4, wherein said tensioning means further comprises a roller carriage upon which said roller is rotatably mounted, with said roller carriage being rotatably or slidably mounted to said base, and with said roller carriage including an adjustment means allowing said roller to be moved and fixed with respect to said to base to thereby remove backlash in or pre-tension said belt means.

7. A motion platform as in claim 6, wherein said tensioning means further comprises a spring that urges said cam carriage against said belt means to establish pre-tension in said belt means.

8. A motion platform as in claim 1, wherein said linear-actuator means is comprised of a servo driving a ball screw, and wherein said driveable element is a ball-screw nut rotatably and translatably attached to said ball screw and slidably attached to said base.

9. A motion platform, comprising:
a table rotatably mounted to a base via a joint means that allows two degrees of rotational freedom;
a belt means X with each distal end attached to said table at points X straddling said joint means;
a linear-actuator means X attached to said base with said linear-actuator means having a driveable element X that is attached to said belt means X such that translation of said driveable element X tensions said belt means X, which in turn pivots said table in a plane X;
at least one pulley means X attached to said base that redirects said belt means X such that said belt means X travels substantially parallel to said linear-actuator means;
a tensioning means X to take up or give slack in said belt means X as a result of geometry changes as said table pivots in said plane X;
a belt means Y with each distal end attached to said table at points Y straddling said joint means, said points Y being substantially orthogonal to said points X;
a linear-actuator Y attached to said base with said linear-actuator means having a driveable element Y that is attached to said belt means Y such that translation of said driveable element Y tensions said belt means Y, which in turn pivots said table in a plane Y substantially orthogonal to said plane X;
at least one pulley means Y attached attached to said base that redirects said belt means Y such that said belt means Y travels substantially parallel to said linear-actuator means Y;
a tensioning means Y to take up or give slack in said belt means Y that occur as a result of geometry changes as said table pivots in said plane Y.

10. A motion platform as in claim 9, wherein said belt means X at each distal end is attached to said table via a belt-joint means X that allows for two degrees of rotational freedom, wherein the center of rotation of said belt-joint means X is collinear with the center of rotation of said joint means; and wherein said belt means Y at each distal end is attached to said table via a belt-joint means Y that allows for two degrees of rotational freedom, wherein the center of rotation of said belt-joint means Y is collinear with the center of rotation of said joint means.

11. A motion platform as in claim 9, wherein said linear-actuator means Y is fixed in said plane Y at an angle with respect to said base such that said belt means Y travels over said linear-actuator means X, thereby increasing the travel length of said linear-actuator means X and Y ultimately the deflection of said table for a given footprint and height of said motion platform.

12. A motion platform as in claim 9, wherein said belt means X runs underneath said linear-actuator means X and wherein said belt means Y runs underneath said linear-actuator means Y, thereby minimizing the height of said motion platform for a given maximum deflection angle of said table.

13. A motion platform as in claim 9, wherein said belt means X and said belt means Y have teeth allowing for positive engagement with a toothed-pulley means.

14. A motion platform as in claim 9, wherein said tensioning means X comprises a cam X affixed to a toothed-pulley means X that engages said belt means X, said toothed-pulley means X rotatably mounted to a cam carriage X that is rotatably or slidably mounted to said base, with said cam X contacting a roller X that is rotatably mounted to said base, whereby translation of said belt means X causes said toothed-pulley means X to rotate in congruence with said cam X, with said cam X urging said cam carriage X to move a distance necessary to take up or give slack to said belt means X as needed to prevent over-tension or under-tension of said belt means X as said table pivots through its range of travel in said plane X; and wherein said tensioning means Y comprises a cam Y affixed to a toothed-pulley means Y that engages said belt means Y, said toothed-pulley means Y rotatably mounted to a cam carriage Y that is rotatably or slidably mounted to said base, with said cam Y contacting a roller Y that is rotatably mounted to said base, whereby translation of said belt means Y causes said toothed-pulley means Y to rotate in congruence with said cam Y, with said cam Y urging said cam carriage Y to move a distance necessary to take up or give slack to said belt means Y as needed to prevent over-tension or under-tension of said belt means Y as said table pivots through its range of travel in said plane Y.

15. A motion platform as in claim 14, wherein said cam X can be rotatably adjusted and fixed at a certain angle with respect to said toothed-pulley means X to adjust and set timing between said cam X and said belt means X; and wherein said cam Y can be rotatably adjusted and fixed at a certain angle with respect to said toothed-pulley means Y to adjust and set timing between said cam Y and said belt means Y.

16. A motion platform as in claim 14, wherein said tensioning means X further comprises a roller carriage X upon which said roller X is rotatably mounted, with said roller carriage X being rotatably or slidably mounted to said base, and with said roller carriage X including an adjustment means X allowing said roller X to be moved and fixed with respect to said to base to thereby remove backlash in or pre-tension said belt means X; and wherein said tensioning means Y further comprises a roller carriage Y upon which said roller Y is rotatably mounted, with said roller carriage Y being rotatably or slidably mounted to said base, and with said roller carriage Y including an adjustment means Y allowing said roller Y to be moved and fixed with respect to said to base to thereby remove backlash in or pre-tension said belt means Y.

17. A motion platform as in claim 14, wherein said tensioning means X further comprises a spring X that urges said cam carriage X against said belt means X to establish pre-tension in said belt means X; and wherein said tensioning means Y further comprises a spring Y that urges said cam carriage Y against said belt means Y to establish pre-tension in said belt means Y.

18. A motion platform as in claim 14, wherein said linear-actuator means X is comprised of a servo X driving a ball screw X, and wherein said driveable element X is a ball-screw nut X rotatably and translatably attached to said ball screw X and slidably attached to said base; and wherein said linear-actuator means Y is comprised of a servo Y driving a ball screw Y, and wherein said driveable element Y is a ball-screw nut Y rotatably and translatably attached to said ball screw Y and slidably attached to said base.

19. A motion platform, comprising:
a table that can move in at least one and up to six degrees of freedom;
at least one actuator means connecting said table to a base;
a force-measuring means than can measure external forces or external torques or both external forces and external torques on said table, wherein said force-measuring means may include said actuator means;
a programmable-controller means that can drive said actuator means according to a mathematical model comprising a virtual table that can virtually move in at least one and up to six degrees of freedom, said virtual table connected virtually to said table through at least one virtual spring that has a virtual spring rate that is programmable and dynamic and at least one virtual damper with a virtual damping coefficient that is programmable and dynamic; wherein movement commands may be applied to said virtual table with the resulting movement of said table being determined by solving equations of motion for a virtual spring-mass-damper system using said virtual spring rate or rates, said virtual damping coefficient or coefficients, measured external forces or external torques or both external forces and external torques as determined by said force-measuring means, and wherein said mass in said spring-mass-damper system may correspond to virtual moments of inertia of a simulated object such as a virtual surfboard with the moments of inertia of said table and said actuator means factored out.
